(19) United States
(12) Patent Application Publication
(10) Pub. No.: US 2022/0408011 A1
(43) Pub. Date: Dec. 22, 2022

(54) USER CHARACTERISTIC-BASED DISPLAY PRESENTATION

(71) Applicant: HEWLETT-PACKARD DEVELOPMENT COMPANY, L.P., Spring, TX (US)

(72) Inventor: Rafael Dal Zotto, Porto Alegre (BR)

(73) Assignee: HEWLETT-PACKARD DEVELOPMENT COMPANY, L.P., Spring, TX (US)

(21) Appl. No.: 17/351,565

(22) Filed: Jun. 18, 2021

(51) Int. Cl. H04N 5/232; H04N 5/225; G06T 7/80; G06K 9/00

(52) U.S. Cl. CPC H04N 5/23216; H04N 5/22525; G06T 7/80; G06K 9/00885

(57) ABSTRACT

In an example in accordance with the present disclosure, an electronic device is described. The electronic device includes a camera to capture an image of a user facing the electronic device. An image analyzer of the electronic device determines a characteristic of the user from the image of the user. The electronic device also includes a presentation controller. The presentation controller 1) selects a presentation characteristic based on a determined characteristic of the user and 2) alters a display of the electronic device based on a selected presentation characteristic.

### BACKGROUND

Electronic devices are used by millions of people daily to carry out business, personal, and social operations. Examples of electronic devices include desktop computers, laptop computers, all-in-one devices, tablets, smartphones, wearable smart devices, and gaming systems to name a few. Users execute electronic device functionality and communicate with other users and entities via user interfaces of the electronic devices.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an electronic device for selecting display presentation characteristics based on a user characteristic, according to an example of the principles described herein.

FIG. 2 is a flowchart of a method for selecting display presentation characteristics based on a user characteristic, according to an example of the principles described herein.

FIGS. 3A-3C depict user interfaces selected based on user characteristics, according to an example of the principles described herein.

FIG. 4 is a block diagram of an electronic device for selecting display presentation characteristics based on a user characteristic, according to an example of the principles described herein.

FIG. 5 is a flowchart of a method for selecting display presentation characteristics based on a user characteristic, according to an example of the principles described herein.

FIG. 6 depicts a non-transitory machine-readable storage medium for selecting display presentation characteristics based on a user characteristic, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Electronic devices have become commonplace in today's society and it is not uncommon for an individual to interact with multiple electronic devices on a daily basis. Information is presented to the user, and in some examples collected from the user, via a user interface. In other words, the user interface of an electronic device is the gateway through which the user interacts with the electronic device and other users through the electronic device. As electronic devices are becoming more ubiquitous in society, an electronic device that provides a customized presentation of information may enhance their use throughout society.

For example, some users may find a user interface difficult to navigate, which difficulty may prevent the electronic device from providing its intended function, i.e., digital communication and/or digital interaction. That is, an inefficient user interface may be a hindrance to such communication, rather than being a gateway to digital communication. For example, while a particular subset of users may be comfortable with a variety of interfaces, elderly users may not be able to access the full complement of electronic functionality on account of the user interface being inefficient. A similar situation may arise for small children.

As such, the present specification describes a multi-user adaptive interface that may accommodate a diversity of end users by changing the user interface elements automatically based on an automatic detection of the user's age. Specifically, the layout of components on the user interface as well as the size and color of visual assets may be updated based on characteristics of an end user.

Accordingly, the present specification uses machine-learning techniques to detect and associate users with an age-based group. The age-based group of the user triggers the automatic, without additional user intervention, adaptation of the graphical user interface (GUI) based on the estimated age of a user that is in front of the electronic device. As such, the present electronic devices and methods may produce dynamic interfaces that can adjust layouts, component disposition, sizes, colors, and other GUI-related components, based on the detected user age group.

Specifically, the present specification describes an electronic device. The electronic device includes a camera to capture an image of a user facing the electronic device. An image analyzer of the electronic device determines a characteristic of the user from the image of the user. The electronic device also includes a presentation controller. The presentation controller 1) selects a presentation characteristic based on a determined characteristic of the user and 2) alters a display of the electronic device based on a selected presentation characteristic.

The present specification also describes a method. According to the method, a video stream of a user facing an electronic device is captured. The video stream is biometrically analyzed to estimate an age group of the user. Based on the estimated age group of the user, presentation characteristics of the user interface of the electronic device are selected and the user interface is altered based on selected presentation characteristics.

The present specification also describes a non-transitory machine-readable storage medium encoded with instructions executable by a processor of an electronic device. The instructions, when executed by the processor, cause the processor to capture an image of a user facing the electronic device and biometrically analyze, via a machine-learning engine, the image to estimate an age of the user. The instructions, when executed by the processor, cause the processor to classify the user into an age group based on an estimated age of the user and select, based on a determined age group of the user, presentation characteristics of a user interface of the electronic device. The instructions are also executable by the processor to alter the user interface of the electronic device based on selected presentation characteristics of the user interface.

In summary, such a system, method, and machine-readable storage medium may, for example 1) provide a user interface tailored for a user based on characteristics of that particular user; 2) adjust the user interface automatically and without user intervention; and 3) automatically detect the user characteristics which trigger the update to the user interface. However, it is contemplated that the devices disclosed herein may address other matters and deficiencies in a number of technical areas, for example.

As used in the present specification and in the appended claims, the term “a number of” or similar language is meant to be understood broadly as any positive number including 1 to infinity.

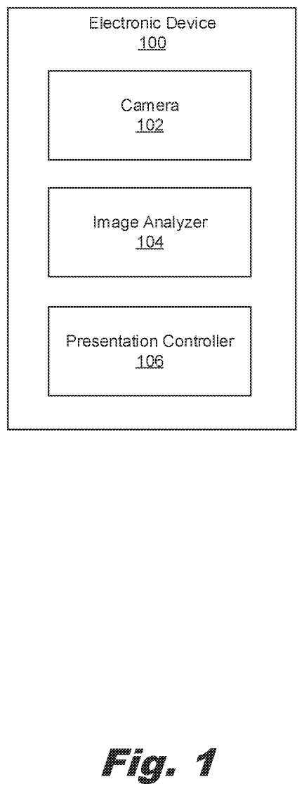

Turning now to the figures, FIG. 1 is a block diagram of an electronic device (100) for selecting display presentation characteristics based on a user characteristic, according to an example of the principles described herein. As described above, the present specification describes an electronic device (100) that automatically updates, without user intervention, various user interface elements based on characteristics of the user that is in front of the electronic device (100). Accordingly, the electronic device (100) includes a component to detect the characteristic of the user. For example, the electronic device (100) may include a camera (102) to capture an image of a user facing the electronic device (100). As used in the present specification, the “camera” refers to any hardware component that may capture an image. That is, the electronic device (100) may include a camera (102) that faces a user sitting or standing in front of the electronic device (100) and that is using the electronic device (100). The camera (102) may be a still image camera (102) or a video camera that captures images or video stream of the user.

In some examples, the image may be captured during biometric authentication of the user. That is, some electronic devices (100) may rely on the camera (102) and/or facial recognition to unlock an electronic device (100). In this example, this same image that is relied on to unlock the electronic device (100) may be used by the image analyzer (104) and presentation controller (106) to 1) estimate an age group of the user and 2) select presentation characteristics, respectively.

The electronic device (100) also includes a component to determine the characteristic of the user from the image of the user. Specifically, the image analyzer (104) may include hardware components such as a processor and/or memory that analyzes the image to determine the user characteristic. In a particular example, the user characteristic that is determined is an age of the user. Features that may be indicative of age include the size of the face, facial feature shape, wrinkles, face contour, and facial feature distribution on the face. As such, the image analyzer (104) may analyze aspects and features of the image to estimate an age of the user. Different users have different facial features, and some of those facial features may be indicative of an age of the user. For example, the position and relative spacing of facial features such as the eyes, the nose, ears, teeth spacing etc. may be unique to a user and size and/or spacing ranges of these features may be indicative of the age of the user. For example, young children may have a smaller head size and may have different eye-spacing relative to the overall head size as compared to adults. As such, the image analyzer (104) may capture these facial measurements and use them to estimate an age of the user. For example, each captured facial measurement may be indicative of a predicated age for the user depicted in the image. In an example, the image analyzer (104) may average the individually collected age predictions.

Note that in some examples, the image analyzer (104) in addition to providing an estimate of the age of a user, may also track the face of the user as it moves. That is, a user may not be stationary in front of the electronic device (100). In this example, the image analyzer (104) may track the movement of the user all while collecting data by which the age of the user may be estimated. Note that such estimations may not be precise, but may provide an approximation of the age of the user.

In an example, the image analyzer (104) is a machine-learning image analyzer (104) that estimates the age group of the user based on a training set of data. That is, the measurements and characteristics of a user that are indicative of age may be determined based on measurements taken from a training set of data of users of a known age. For example, deep learning and convolutional neural networks (CNN) may identify discriminative features on an image directly from the pixels of the image. In general, the image analyzer (104) may detect a face and perform image preprocessing, such as landmark detection and facial alignment, feature extraction, which includes the extraction of relevant features from the input image, and age classification.

For example, the input to the machine-learning image analyzer (104) may be the image of the user. As described above, there may be a relationship between the age of a user and the ability of the user to access the complement of services provided by the electronic device (100). As such, the machine-learning image analyzer (104) receives an input image and processes the image. Specifically, the machine-learning image analyzer (104) may analyze the pixels of the image or video stream to identify certain features of the user depicted in the image or video stream. Doing so, the image analyzer (104) may extract facial features, such as eyes, ears, nose, mouth, and other facial features from the image. The image analyzer (104) may also determine the relative position and/or distance between different facial features. Characteristics of these features, such as the size, shape, position, and/or color may be compared against a training set of data to estimate the age of the user. That is, a training set may include measurements of these characteristics as they relate to users of a known age.

As such, a comparison of the measured features of a user facing the electronic device (100) may be compared against measurements from the training set. A similarity in the measurements of the user and measurements from the training set may be used to indicate that the user facing the electronic device (100) is of the same approximate age as an individual in the training set with similar measurements.

To facilitate the collection of data to supplement the training set, the camera (102) may be activated during a calibration period. For example, a user may input their age to a system and the camera (102), over a calibration period of time, may capture images of the user such that measurements may be taken by which the age of other users may be estimated. In an example, the calibration period may be a period when the camera (102) is not targeted by an application executing on the electronic device (100). That is, many applications such as video conferencing applications may activate, or target, the camera (102) in executing its intended function. Even when the camera (102) is not targeted by an application, the camera (102) may be activated to capture images whereby the training set of data may be updated. In one particular example, the image analyzer (104) includes an age and gender recognition model implemented as a multitask network, which employs a feature extraction layer and an age regression layer.

The electronic device (100) may also include a presentation controller (106). In general, the presentation controller (106) manages the presentation of visual elements on the display of an electronic device (100). In some examples, this may be based on metadata and/or a database that indicates what visual elements are to be presented and how those visual elements are to be presented. The presentation controller (106) may select a presentation characteristic based on a determined characteristic of the user and may alter a display of the electronic device (100) based on a selected presentation characteristic.

That is, as described above, visual information may be presented in any number of ways and user interfaces have different presentation characteristics. The present electronic device (100) automatically updates these presentation characteristics based on an automatically detected user age. That is, rather than relying on user input to update some characteristics, the present electronic device (100) does so automatically and may update a variety of presentation characteristics at the same time.

Examples of presentation characteristics that may be adjusted include a color scheme for the display. For example, younger users may respond better to a brighter display with more colors where as an older user may prefer a more muted pallet. As another example, the user input elements to be presented on the display may be altered. For example, a user interface to be used for a user who is able to read may include buttons with text such as “home,” “next page,” and “previous page.” A user interface to be used for a younger user may replace this text with graphical indications. In another example, the font size, of the user input elements or others, may be enlarged. In yet another example, the font type may be adjusted. For example, for users learning to read, an upper-case font may be easier to read. As yet another example, instructional text may be added or hidden based on a determined age group for the user of the electronic device (100).

As yet another example, the graphics and/or content to be presented on the display of the electronic device (100) may be altered. Still further, a user interface layout of the display may be selected. That is, the position and relative arrangement of different components of the visual display may be selected. As yet another example, audio content may be presented on the electronic device (100). That is, for users who cannot read or who suffer from visual impairment, which may be indicated by an estimated age group, instead of including textual content, audio content may be provided on the electronic device (100).

In some examples, a first presentation characteristic is associated with both a first age group and a second age group. That is, presentation characteristics may be common among different age classifications. While particular reference is made to a few presentation characteristics, any number of presentation characteristics may be selected and/or altered based on the estimated age group for a user.

As such, the present specification relies on machine-learning models to estimate an age of a user and to automatically adapt visual interfaces, by for example, adjusting their layout and components. As compared to other solutions, the present specification selects the changes based on image analysis of a user and may do so without user intervention whereas other systems rely on a user manually changing the user interface elements.

As used in the present specification and in the appended claims, the term, the presentation controller (106) and the image analyzer (104) may include a processor, an application-specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer-usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the respective component, cause the component to implement at least the functionality described herein.

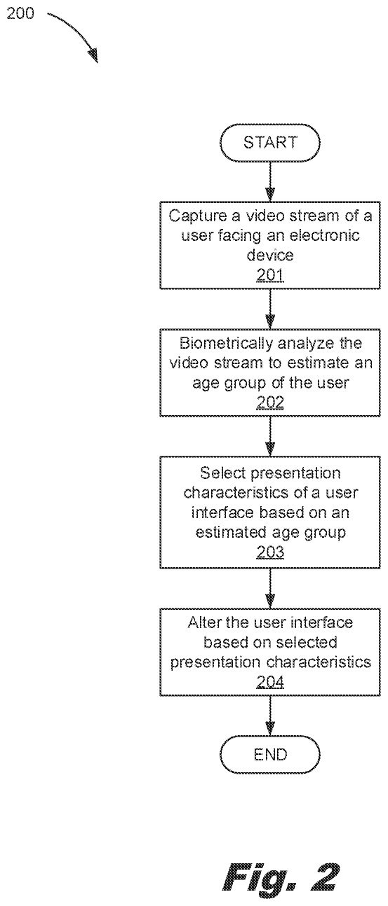

FIG. 2 is a flowchart of a method (200) for selecting display presentation characteristics based on a user characteristic, according to an example of the principles described herein.

According to the method (200), a video stream of a user facing the electronic device (FIG. 1, 100) is captured (block 201). As described above, this may be performed during biometric authentication or using an interface wherein the camera (FIG. 1, 102) is actively targeted. In this later example, an output of the camera (FIG. 1, 102) may be presented wherein the user may visualize the output as the camera (FIG. 1, 102) records and in some cases tracks their movement. In another example, no visual cue may be provided to the user. In this example, the image may be captured (block 201) and the user interface updated without the user having any visual cue that it is happening. That is, the method (200) may be a background operation or may use additional sensors to aid in the activation of the camera.

The method (200) may include biometrically analyzing (block 202) the video stream to estimate an age group of the user. That is, as described above certain facial features may be indicative of an age of the user. As noted above, such an estimation may not be precise, but may classify the user as falling within a particular age group for which certain presentation characteristics are to be selected. Examples of age groups include a 0-14 age group, a 15-47 age group, a 48-63 age group, and an over 64 age group. Each of these age groups may map to particular presentation characteristics. For example, the presentation layout for a user between the ages of 0 and 14 may differ from the presentation layout when a user over the age of 64 is detected facing the electronic device (FIG. 1, 100). While the present specification describes particular age groups, different age groups and different numbers of age groups may be determined according to the principles described herein. For example, to have a more tailored experience, the 0-14 age groups may be separated into a 0-7 age group and a 7-14 age group.

In some examples, in addition to being based on biometric information, the estimated age may be determined based on additional information such as content consumed, applications executed, data input or combinations thereof. This additional input may provide additional data points wherein the electronic device (FIG. 1, 100) may estimate an age of the user of the electronic device (FIG. 1, 100). As an example, in addition to any biometrically captured information, the electronic device (FIG. 1, 100) may determine that a user is actively viewing a world news article. This may verify any determination by the image analyzer (FIG. 1, 102) that the user is in the 15-47, 48-63, or over 64 age group. Similarly, applications that are executed or direct user input may be used to verify the estimated age of a user. While particular reference is made to certain types of supplemental information that may be used to aid in the estimation of the age of a user. Any variety of other pieces of information may similarly be used to determine the age of a user.

As described above, a presentation controller (FIG. 1, 106) may 1) select (block 203) presentation characteristics of a user interface based on an estimated age group for the user and 2) alter (block 204) the user interface of the electronic device (FIG. 1, 100) based on selected presentation characteristics of the user interface. In an example, altering (block 203) the user interface includes flipping certain pixels so as to present the content as determined from the user age group. As such, users are classified based on an estimated age into different groups such that different information may be visually presented to the user in a tailored fashion.

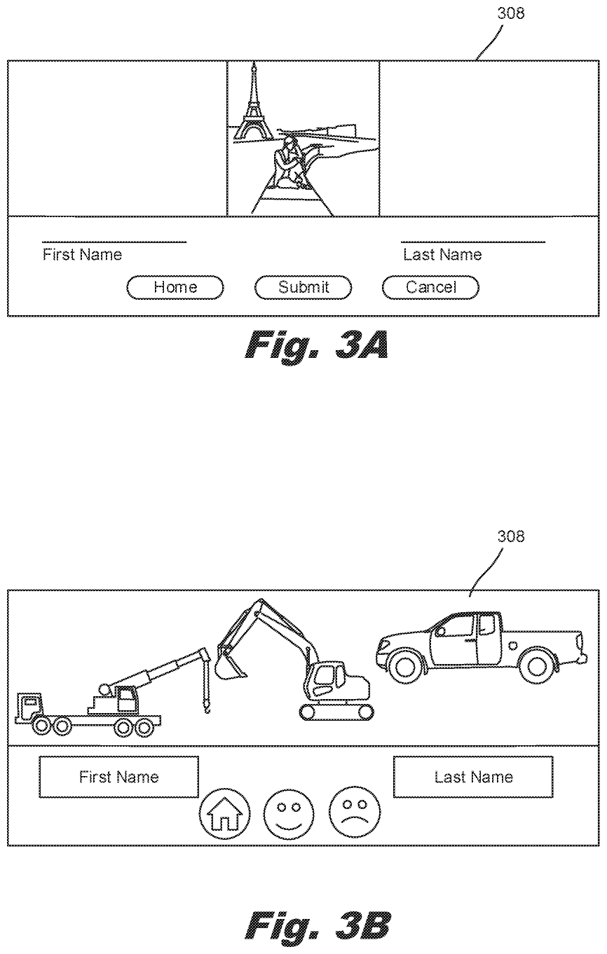

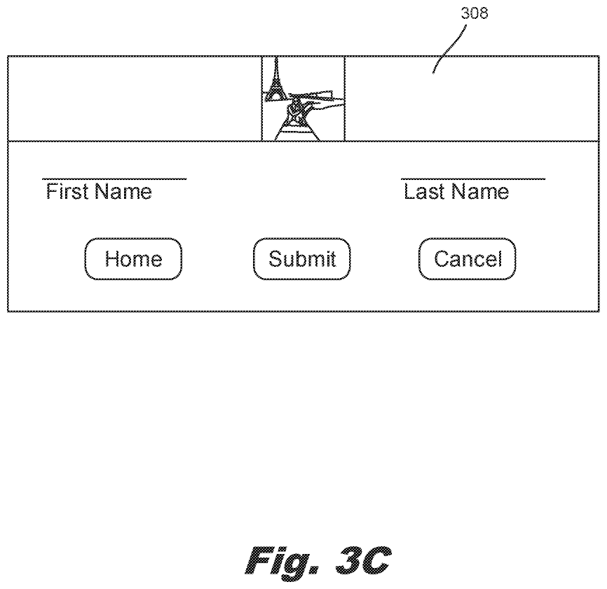

FIGS. 3A-3C depict user interfaces (308) with visual elements selected based on user characteristics, according to an example of the principles described herein. As described above, it may be that the presentation of certain visual information may be more difficult for certain demographics to absorb. For example, younger users and others may have certain physiological and cognitive challenges in interfacing with an electronic device (FIG. 1, 100). As a particular example, as a user ages, their vision may deteriorate. Accordingly, as depicted in FIG. 3C, presentation elements of the user interface (308) may be enlarged to accommodate for any vision loss. Likewise, user interfaces (308) tailored for a child may include less textual description as depicted in FIG. 3B as textual description may be difficult for a young child to understand and interact with. As such, the electronic device (FIG. 1, 100) may classify users based on age and have different sets of presentation elements associated with each age group.

In the example depicted in FIG. 3A, a user interface (308) is provided which includes a graphic of an individual sitting in a landscape, fields for a “first name” a “last name” as well as user input buttons for “home,” “submit” and “cancel.” Such an interface may be selected for a user in the 15-47 and/or 48-63 age groups.

FIG. 3B depicts a user interface (308) that has been selected based on the user facing the electronic device (FIG. 1, 100) being identified as pertaining to a younger age group. In this example, the small graphic of a user in a landscape has been replaced with a larger graphic including a variety of toy trucks. Also in this example, the first name and last name fields have been altered to be buttons, rather than lines on top of which the text is to appear. Furthermore, in this example, the “home,” “submit,” and “cancel,” buttons have been replaced with graphic icons that may more clearly indicate to a child user how to accomplish he intended function of the user input element.

FIG. 3C depicts a user interface (308) that has been selected based on the user facing the electronic device (FIG. 1, 100) being identified as pertaining to an older age group. In this example, the graphic has been reduced in size to accommodate the larger font size of both the fields and the user input buttons selected for a user in an older age group. Again, while FIGS. 3A-3C depict particular presentation characteristic selections, a variety of other elements may be similarly selected and/or altered based on the age group associated with a user sitting or standing in front of an electronic device (FIG. 1, 100)

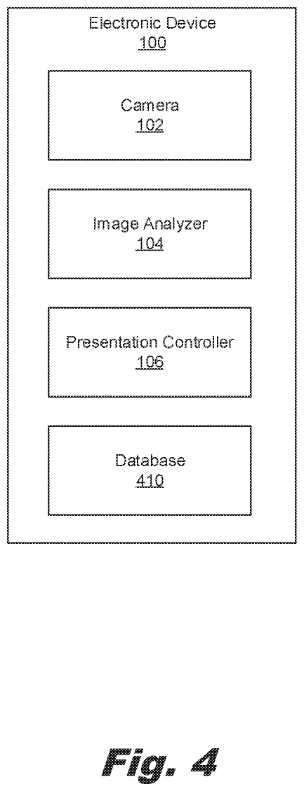

FIG. 4 is a block diagram of an electronic device (100) for selecting display presentation characteristics based on a user characteristic, according to an example of the principles described herein. As described above, the electronic device (100) may include a camera (102), image analyzer (104), and presentation controller (106). In this example, the electronic device (100) may include other components. For example, the electronic device (100) may include a database (410) of user interface elements and age-based variants of each user interface element. That is, a digital file may define and identify the user interface components, such as font sizes, icons, graphics, etc. In this example, the database (410) may include variants of each of these and may contain a mapping between the variants and the different age group classifications. For example, for a “home” user input element, a first variant may be a button with the text “home” in a certain font size. This variant may be associated with the 15-47 and 48-63 age groups. A 0-7 and 7-14 age group variant of this element may be an icon of the home rather than the text “home.” Similarly, the over 64 age group variant of this element may be the text “home” but in a larger font size. As such, the database includes a mapping between age groups and the different presentation characteristics that are associated with that age group and that will be presented when a user of the associated age group is detected.

As depicted in FIG. 4, it may be that all of the components are on the electronic device (100) itself. In other examples, the components, such as the image analyzer (102), the presentation controller (104), or the database (410) may be on a separate device. Maintaining these components on the electronic device (100) may provide enhanced security as the images of the user as well as the estimated age may be preserved on the electronic device (100) rather than being disseminated over a network. That is, the information that is captured by the camera (102) along with the age estimations are used locally, at the electronic device (100).

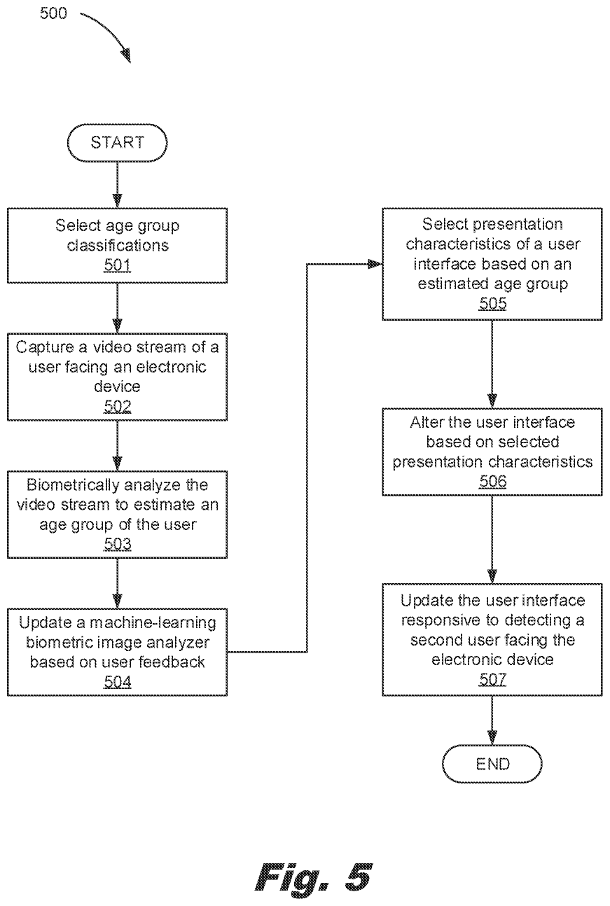

FIG. 5 is a flowchart of a method (500) for altering display presentation characteristics based on a user characteristic, according to an example of the principles described herein. According to the method (500), age group classifications are selected (block 501) for which there are to be different presentation characteristics of the user interface. That is, as described above, there may be any variety of presentation characteristics that are customizable, and the method (500) may include identifying which age groups the customized options are tailored for. Selecting (block 501) the age group classifications may include identifying the mapping between age group classifications and associated customized options.

The method (500) may further include capturing (block 502) a video stream of a user facing an electronic device (FIG. 1, 100) and biometrically analyzing (block 503) the video stream to estimate an age group associated with the user. These operations may be performed as described above in connection with FIG. 2.

As described above, the image analyzer (FIG. 1, 104) may be a machine-learning image analyzer that operates based on a training set of information. As such, the method (500) may include updating (block 504) the machine-learning biometric image analyzer (FIG. 1, 104) based on feedback regarding determined age group estimation. That is, after a user has been estimated to pertain to a particular age group, the user may input information indicating whether the estimation was correct and/or providing their actual age. This information may supplement the information in the training set such that future estimations of age may be more accurate.

Additionally, the presentation characteristics may be selected (block 505) and the user interface altered (block 506) as described above in connection with FIG. 2.

In some examples, the method (500) may further include updating (block 507) the user interface in real-time responsive to detecting a second user facing the electronic device (FIG. 1, 100). That is, multiple users may use a single electronic device (FIG. 1, 100) but at different times. Accordingly, a dynamic and real-time alteration of the presentation of visual information may allow a single electronic device (FIG. 1, 100) to be customized to multiple different individuals. Such a dynamic presentation alteration may increase productivity as each user is presented with a user interface that is specifically tailored to them.

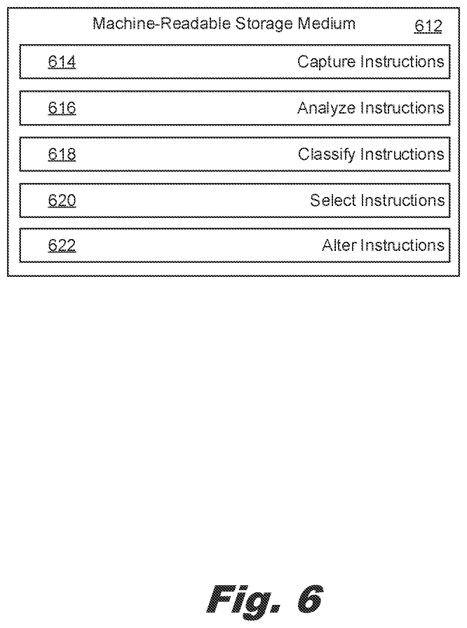

FIG. 6 depicts a non-transitory machine-readable storage medium (612) for altering display presentation characteristics based on a user characteristic, according to an example of the principles described herein. To achieve its desired functionality, the electronic device (FIG. 1, 100) includes various hardware components. Specifically, the electronic device (FIG. 1, 100) includes a processor and a machine-readable storage medium (612). The machine-readable storage medium (612) is communicatively coupled to the processor. The machine-readable storage medium (612) includes a number of instructions (614, 616, 618, 620, 622) for performing a designated function. In some examples, the instructions may be machine code and/or script code.

The machine-readable storage medium (612) causes the processor to execute the designated function of the instructions (614, 616, 618, 620, 622). The machine-readable storage medium (612) can store data, programs, instructions, or any other machine-readable data that can be utilized to operate the electronic device (FIG. 1. 100). Machine-readable storage medium (612) can store machine readable instructions that the processor of the electronic device (FIG. 1, 100) can process, or execute. The machine-readable storage medium (612) can be an electronic, magnetic, optical, or other physical storage device that contains or stores executable instructions. Machine-readable storage medium (612) may be, for example, Random-Access Memory (RAM), an Electrically Erasable Programmable Read-Only Memory (EEPROM), a storage device, an optical disc, etc. The machine-readable storage medium (612) may be a non-transitory machine-readable storage medium (612).

Referring to FIG. 6, capture instructions (614), when executed by the processor, cause the processor to, capture an image of a user facing an electronic device (FIG. 1, 100). Analyze instructions (616), when executed by the processor, cause the processor to, biometrically analyze, via a machine-learning engine, the image to estimate an age of the user. Classify instructions (618), when executed by the processor, cause the processor to classify the user into an age group based on an estimated age of the user. Select instructions (620), when executed by the processor, also cause the processor to, select, based on a determined age group of the user, presentation characteristics of a user of the electronic device (FIG. 1, 100). Alter instructions (622), when executed by the processor, also cause the processor to, alter the user interface of the electronic device based on selected presentation characteristics of the user interface.

In summary, such a system, method, and machine-readable storage medium may, for example 1) provide a user interface tailored for a user based on characteristics of that particular user; 2) adjust the user interface automatically and without user intervention; and 3) automatically detect the user characteristics which trigger the update to the user interface. However, it is contemplated that the devices disclosed herein may address other matters and deficiencies in a number of technical areas, for example.

The status and content of each claim follows.

1. An electronic device, comprising:
a camera to capture an image of a user facing the electronic device;
an image analyzer to determine a characteristic of the user from the image of the user; and
a presentation controller to:
select a presentation characteristic based on a determined characteristic of the user;
select a layout of a visual display of the electronic device based on the determined characteristic of the user; and
alter a display of the electronic device based on a selected presentation characteristic and a selected layout.

2. The electronic device of claim 1, wherein the image analyzer is a machine-learning image analyzer to determine an age group of the user based on a training set of data.

3. The electronic device of claim 2, wherein the camera is activated during a calibration period to update the training set of data.

4. The electronic device of claim 3, wherein the calibration period is a period when the camera is not targeted by an application executing on the electronic device.

5. The electronic device of claim 1, wherein a presentation characteristic is selected from the group consisting of:
a color scheme for the display;
a user input element to be presented on the display;
a graphic to be presented on the display;
a font size;
content to be presented on the display;
a user interface layout of the display; and
audio content to be presented through the electronic device.

6. The electronic device of claim 1, further comprising a database of user interface elements and age-based variants of each user interface element.

7. A method, comprising:
capturing a video stream of a user facing an electronic device;
biometrically analyzing the video stream to estimate an age group of the user;
selecting, based on an estimated age group of the user:
presentation characteristics of a user interface of the electronic device; and
a layout and arrangement of components of the user interface of the electronic device;
altering the user interface of the electronic device based on selected presentation characteristics of the user interface; and
providing additional content to the user interface based on an estimated age group of the user.

8. The method of claim 7, further comprising selecting age group classifications for which there are to be different presentation characteristics of the user interface.

9. The method of claim 7, further comprising updating a machine-learning biometric image analyzer based on feedback regarding determined age group estimation.

10. The method of claim 7, wherein an estimated age group is based on additional information.

11. The method of claim 10, wherein the additional information comprises:
content consumed;
applications executed;
data input; or
combinations thereof.

12. The method of claim 7, further comprising updating the user interface in real-time responsive to detecting a second user facing the electronic device.

13. A non-transitory machine-readable storage medium encoded with instructions executable by a processor of an electronic device to, when executed by the processor, cause the processor to:
capture an image of a user facing the electronic device;
biometrically analyze, via a machine-learning engine, the image to estimate an age of the user;
classify the user into an age group based on an estimated age of the user;
select, based on a determined age group of the user:
presentation characteristics of a user interface of the electronic device; and
a layout and arrangement of components of the user interface of the electronic device;
alter the user interface of the electronic device based on selected presentation characteristics of the user interface; and
provide additional content to the user interface based on an estimated age group of the user.

14. The non-transitory machine-readable storage medium of claim 13, wherein a first presentation characteristic is associated with both a first age group and a second age group.

15. The non-transitory machine-readable storage medium of claim 13, wherein the image is captured during biometric authentication of the user.

16. The electronic device of claim 1, wherein the presentation controller is to alter a display of the electronic device by replacing textual content with audio content.

17. The electronic device of claim 1, wherein the presentation controller is to alter a display of the electronic device by replacing textual content with graphical indications.

18. The electronic device of claim 1, wherein the image of the user forms part of a training set for another electronic device.

19. The method of claim 7, wherein the additional content comprises instruction text.

20. The method of claim 7, wherein altering the user interface comprises reducing a size of a graphic to accommodate text with an increased font size.
